(19) United States
(12) Patent Application Publication
(10) Pub. No.: US 2026/0184180 A1
(43) Pub. Date: Jul. 2, 2026

(54) REDUNDANT POWER STRUCTURE FOR BATTERY MANAGEMENT UNIT

(71) Applicant: VISTEON GLOBAL TECHNOLOGIES, INC., Van Buren Township, MI (US)

(72) Inventors: Theodore T. Kim, Rochester Hills, MI (US); Tao Wang, Oakland Twp., MI (US); Mathew E. Breton, Westland, MI (US)

(73) Assignee: VISTEON GLOBAL TECHNOLOGIES, INC., Van Buren Township, MI (US)

(21) Appl. No.: 19/435,841

(22) Filed: Dec. 30, 2025

Related U.S. Application Data
(60) Provisional application No. 63/741,264, filed on Jan. 2, 2025.

(51) Int. Cl. B60L 3/00; H01M 10/42; H02J 1/08

(52) U.S. Cl. CPC B60L 3/0046; H01M 10/425; H02J 1/086; H01M 2010/4271; H01M 2220/20

(57) ABSTRACT

A system includes a low-voltage battery operational to present a low-voltage electrical power, a rechargeable energy storage system operational to present a high-voltage electrical power, and a battery management unit electrically coupled to the low-voltage battery and the rechargeable energy storage system. The battery management unit includes a control circuit operational to consume the low-voltage electrical power, a flyback transformer operational to convert the high-voltage electrical power into the low-voltage electrical power, and the rechargeable energy storage system, a first path operational to transfer the low-voltage electrical power from the low-voltage battery to the control circuit, and a second path coupled to the first path and operational to transfer the low-voltage electrical power from the flyback transformer to the control circuit.

### CROSS-REFERENCE TO RELATED APPLICATIONS

This application claims the benefit of U.S. Provisional Application No. 63/741,264, filed Jan. 2, 2025, which is hereby incorporated by reference in its entirety.

### TECHNICAL FIELD

The present disclosure generally relates to systems and methods for a redundant power structure for a battery management unit.

### BACKGROUND

If a battery management unit (BMU) of an electric vehicle loses electrical power, the lack of power causes the BMU to lose a monitoring function, that may result in unpredictable conditions. Current state-of-art redundant power architectures use an always-on fly-back transformer on a high-voltage side to generate power on a low-voltage side. Diodes combine the power rails between a low-voltage battery and the fly-back transformer second side. Since the always-on circuity consumes power from the high-voltage side, a total power consumption is higher than if the always-on circuit was not present.

Accordingly, those skilled in the art continue with research and development efforts in the field of power structures for battery management units.

### SUMMARY

A system is provided herein. The system includes a low-voltage battery operational to present a low-voltage electrical power, a rechargeable energy storage system operational to present a high-voltage electrical power, and a battery management unit electrically coupled to the low-voltage battery and the rechargeable energy storage system. The battery management unit includes a control circuit operational to consume the low-voltage electrical power, a flyback transformer operational to convert the high-voltage electrical power into the low-voltage electrical power, and the rechargeable energy storage system, a first path operational to transfer the low-voltage electrical power from the low-voltage battery to the control circuit, and a second path coupled to the first path and operational to transfer the low-voltage electrical power from the flyback transformer to the control circuit.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a schematic diagram of a first implementation of a system in accordance with one or more exemplary embodiments.

FIG. 2 illustrates a schematic diagram of a second implementation of the system in accordance with one or more exemplary embodiments.

FIG. 3 illustrates a schematic diagram of a third implementation of the system in accordance with one or more exemplary embodiments.

FIG. 4 illustrates a schematic diagram of a fourth implementation of the system in accordance with one or more exemplary embodiments.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a system and/or method that generally enhances power supplied to control circuitry within a battery management unit (BMU) of a vehicle by preventing power loss due to single fault. The single fault may include, but is not limited to, a low-voltage battery of the vehicle becoming drained and/or a harness disconnection. The redundant power in the BMU may keep the BMU control circuitry alive, even when the vehicle is in an “off state”.

While the vehicle is in a running mode or a charging mode, a high-voltage high-power DC-to-DC converter may be used to supply a redundant source of low-voltage electrical power. If the DC-to-DC converter is switched off while the vehicle is off, leaving a sole power source (e.g., the low-voltage battery) is available for the electronics within the BMU. Therefore, embodiments of the system/method may include voltage comparison circuit, Boolean ORing circuit, isolation trigger circuity, and flyback circuity in the battery management unit (BMU) to provide a low-quiescent, high robust redundant power structure to supply the low-voltage electrical power to a logic section (including the BMU control circuit) of the BMU.

The enhancements generally involve at least three parts as follows. An improvement to the existing technology is provided by reducing quiescent current from a high-voltage rechargeable energy storage system. Increasing a current rating of the redundant supply from high-voltage side by using ideal diode technology. Furthermore, implement a switching system with a protection device on the high-voltage island side of two independent battery banks within a switchable RESS by connecting the two battery banks in series to allow the banks to share a same load current.

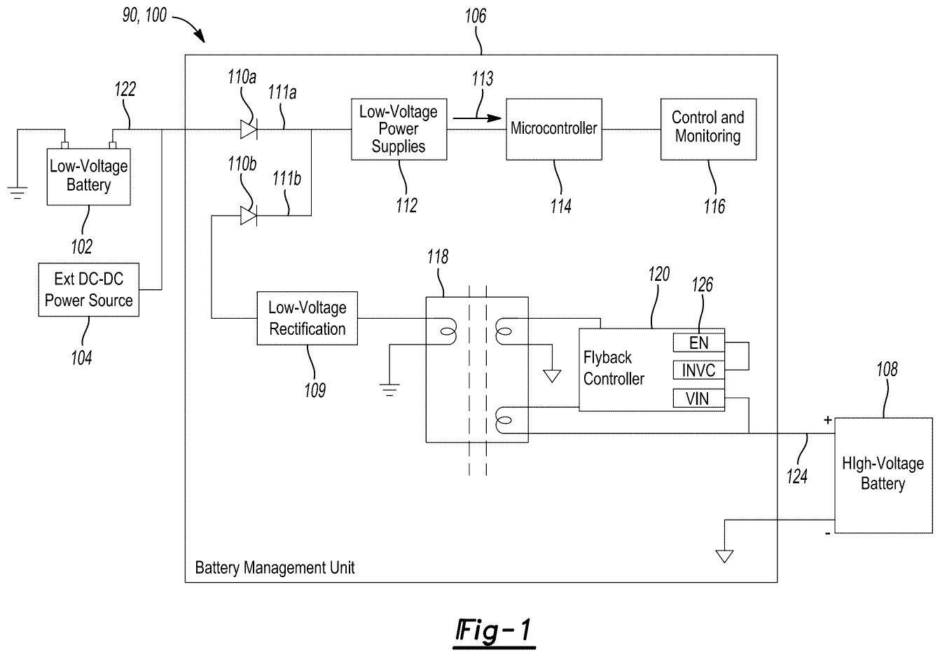

FIG. 1 illustrates a schematic diagram of a first example implementation of a system 100 in accordance with one or more exemplary embodiments. The system 100 includes a low-voltage battery 102, an optional bi-directional DC-to-DC converter 104, a battery management unit (BMU) 106, and a rechargeable energy storage system (RESS) 108. The BMU 106 includes a low-voltage rectification circuit 109, a pair of diodes (e.g., a first diode 110a and a second diode 110b), one or more low voltage power supplies 112, a microcontroller (uC) 114, BMU control circuit (or circuitry) 116, a flyback transformer 118, and a flyback controller 120. The low-voltage battery 102 and the RESS 108 provide redundant power sources. An architecture of the redundant BMU power structure generally reduces a high-voltage side quiescent current drawn from the RESS 108. In various embodiments, the system 100 may be implemented as part of a vehicle 90.

The vehicle 90 may include mobile vehicles such as automobiles, trucks, motorcycles, boats, trains and/or aircraft. In some embodiments, the system 100 may be part of a stationary object. The stationary objects may include, but are not limited to, billboards, kiosks, and/or marquees. The system 100 may be implemented in other types of platforms to meet the design criteria of a particular application.

The low-voltage battery 102 may operate at a voltage 122 of approximately 6 volts DC to approximately 16 volts DC (e.g., 12 volts DC). The RESS 108 may operate at a voltage 124 of approximately 48 volts DC to approximately 950 volts DC (e.g., 800 volts DC). A first path 111a through the first diode 110a transfers the low-voltage electrical power 113 from the low-voltage battery 102 to the control circuit 116 via the low voltage power supplies 112 and the microcontroller 114. A second path 111b through the second diode 110b, coupled to the first path 111a, transfers a flow of the low-voltage electrical power 113 from the flyback transformer 118 to the control circuit 116.

The low-voltage rectification circuit 109 is operational to rectify the AC electrical power received from the flyback transformer 118 to produce DC electrical power presented to the second diode 110b.

The low voltage power supplies 112 is operational to manage the low-voltage electrical power received from the first path 111a and the second path 111b. The management may include filtering and regulating the low-voltage electrical power 113 before presenting the power to the microcontroller 114.

The flyback controller 120 may be activated by applying a control signal to an enable pin 126 of the flyback controller 120. While activated, the flyback controller 120 is operational to convert direct-current power from the RESS 108 into an alternating-current power. The alternating-current power is applied to the flyback transformer 118, inductively coupled to the second path 111b on the other side of the flyback transformer 118, and rectified by the second diode 110b. The resulting draw from the RESS 108 may be no more than a few hundred microampere current from the high-voltage RESS 108.

The flyback transformer 118 is operational to convert the high-voltage electrical power received from the RESS 108 into the low-voltage electrical power 113 suitable to power the control circuit 116 and other low-voltage circuits within the BMU 106.

The BMU control circuit 116 is operational to control a charging and a discharging of the RESS 108. In various embodiments where a switchable RESS 108 is implemented, the BMU control circuit 116 may also configure the two battery banks of the switchable RESS 108 to alternatively operate in parallel and in series.

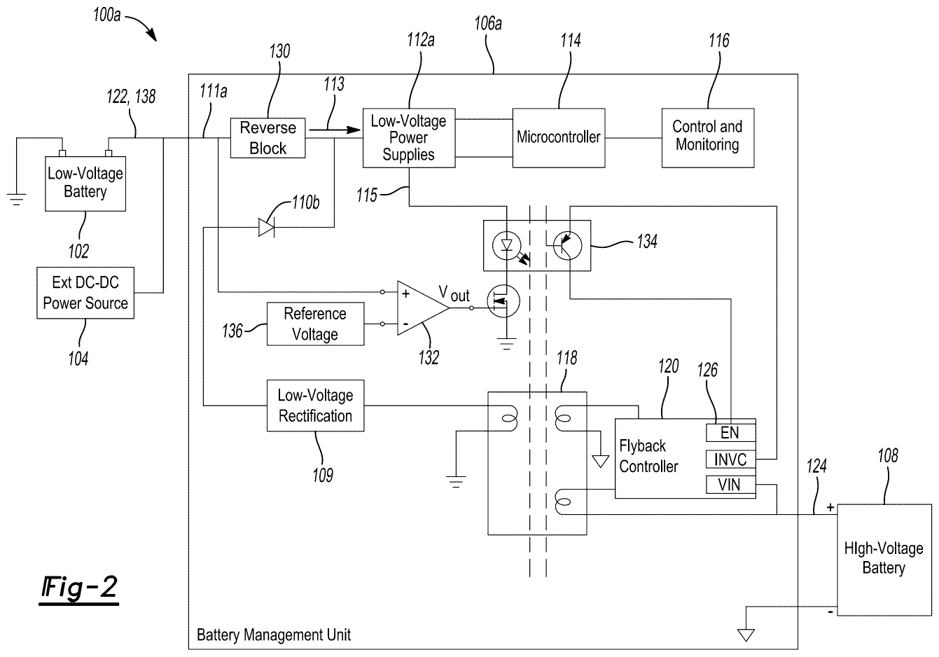

FIG. 2 illustrates a schematic diagram of a second example implementation of the system 100a in accordance with one or more exemplary embodiments. The system 100a illustrated in FIG. 2 may be a variation of the system 100 illustrated in FIG. 1. The system 100a illustrated in FIG. 2 includes the low-voltage battery 102, the optional bi-directional DC-to-DC converter 104, another battery management unit (BMU) 106a, and the rechargeable energy storage system (RESS) 108. The BMU 106a includes the low-voltage rectification circuit 109 109, the second diode 110b, low voltage power supplies 112a, the microcontroller (uC) 114, the BMU control circuit 116, the flyback transformer 118, and the flyback controller 120. The BMU 106a further includes a reversed block 130, a comparator 132, a phototransistor 134 and a reference voltage 136.

The low voltage power supplies 112a may be a variation of the low voltage power supplies 112 shown in FIG. 1. The low voltage power supplies 112a is operational to provide an always-on power 115 to a photodiode in the phototransistor 134.

The reversed block 130 is operational to allow the low-voltage electrical power to flow unidirectionally from the low-voltage battery 102 along the first path 111a to the low voltage power supplies 112. The reversed block 130 is further operational to block the low-voltage electrical power 113 received along the second path 111b through a metal-oxide field-effect transistor (MOSFET) 150 from reaching the low-voltage battery 102. In various embodiments, the reversed block 130 may implement as one or more diodes.

The comparator 132 and the phototransistor 134 control the enable pin 126 of the flyback controller 120 to keep the flyback transformer 118 in a shut-down state when not appropriate. While the input voltage 122 in the BMU 106a from the low-voltage battery 102 is less than a given threshold, the low-voltage battery 102 is (i) operating in an undervoltage condition (e.g., less than a reference voltage 136) or (ii) a harness 138 connecting the low-voltage battery 102 to the BMU 106a is disconnected. Therefore, the comparator 132 may trigger the phototransistor 134 to switch on and activate the enable pin 126 of the flyback controller 120. In response, the power supplied to the low voltage power supplies 112 may be shifted to the (redundant) second path 111b to convey the electrical power delivered from the RESS 108 to the circuitry inside the BMU 106a. While the input voltage 122 in the BMU 106 from the low-voltage battery 102 is above the given threshold, the flyback controller 120 is switched off and thus deactivates the enable pin 126 on the flyback controller 120. As such, the power supplied to the low voltage power supplies 112 would be solely from the low-voltage battery 102 along the first path 111a and not from the RESS 108. This would reduce the power load on the RESS 108 and increase the driving range.

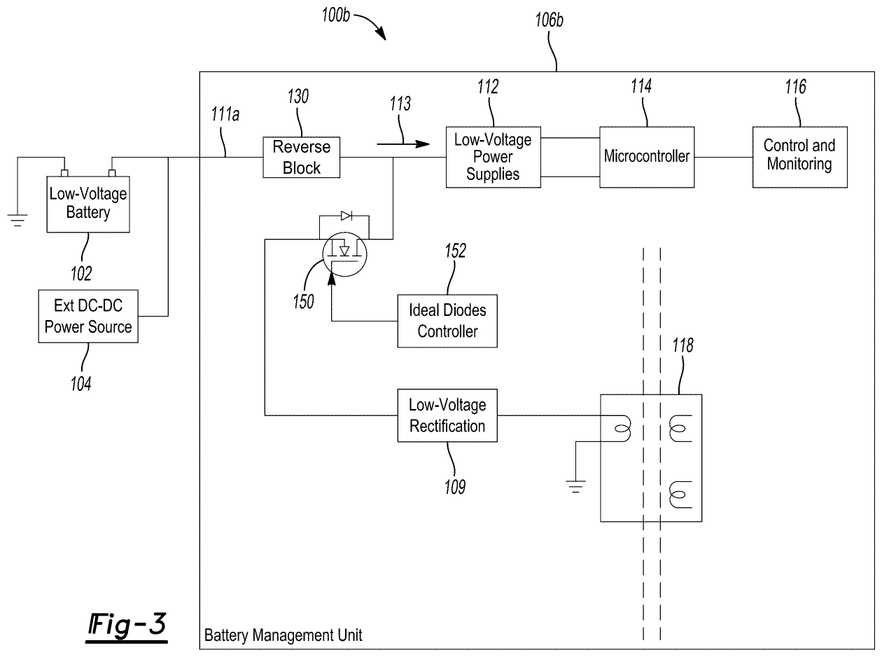

FIG. 3 illustrates a schematic diagram of a third example implementation of the system 100b in accordance with one or more exemplary embodiments. The system 100b illustrated in FIG. 3 may be a variation of the system 100 and/or 100a illustrated in FIG. 1 and/or FIG. 2. The system 100b illustrated in FIG. 3 includes the low-voltage battery 102, the optional bi-directional DC-to-DC converter 104, still another battery management unit (BMU), 106b and the RESS 108. The system 100b further includes a MOSFET (or transistor) 150 and an ideal diode controller 152.

The ideal diode controller 152 and MOSFET 150 form a Boolean OR of the low-voltage electrical power 113 received from the low-voltage battery 102 and the RESS 108 instead of the diodes 110a-110b (FIG. 1). Implementation of the MOSFET 150 and the ideal diode controller 152 generally increases a current capability and reduces thermal losses on the devices inside the BMU 106b.

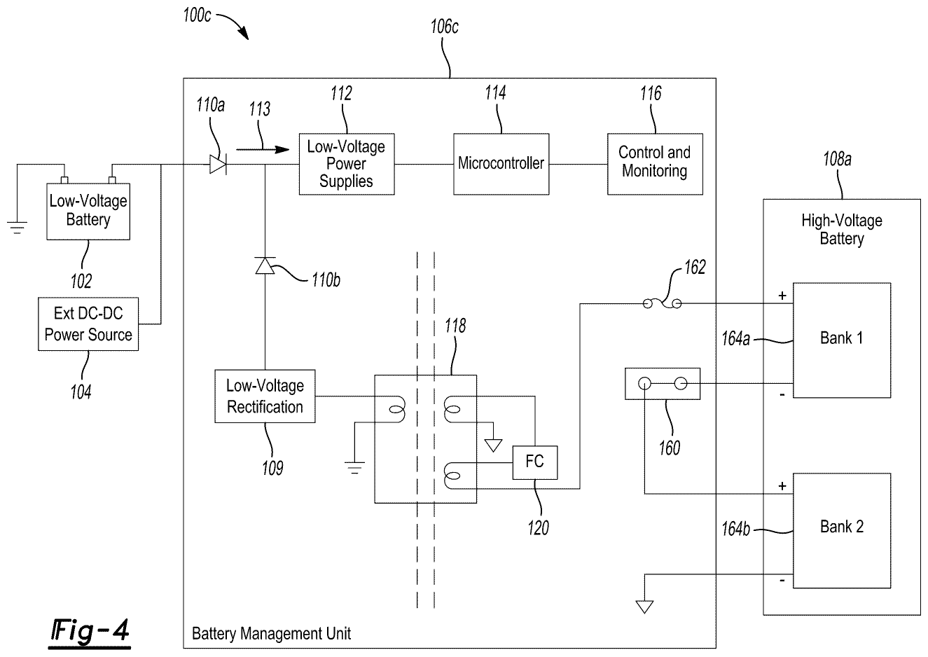

FIG. 4 illustrates a schematic diagram of a fourth example implementation of the system 100c in accordance with one or more exemplary embodiments. The system 100c illustrated in FIG. 4 may be a variation of the system 100, 100a and/or 100b illustrated in FIG. 1, FIG. 2 and/or FIG. 3. The system 100c illustrated in FIG. 4 includes the low-voltage battery 102, the optional bi-directional DC-to-DC converter 104, yet another battery management unit (BMU) 106c, and a switchable RESS 108a. The system 100c further includes a switch 160 and a thermal fuse 162. The switchable RESS 108a in the system of FIG. 4 has two banks 164a and 164b that may be alternatively connected in series (as illustrated) and in parallel.

The switch 160 is operational to connect the two battery banks 164a-164b in series to allow the two banks 164a-164b to share a same load current. The sharing generally prevents an imbalance from developing between the two independent battery banks 164a-164b which is ideal for the technique. The thermal fuse 162 on the power line 166 of battery bank 164a inputs acts as passive protection to prevent internal over-current and/or protect from short circuiting.

Various embodiments of the disclosure provide a circuit and/or method for reducing a quiescent current from high voltage RESS for redundant power supply inside a BMU. The electrical circuitry inside the BMU includes a comparator, voltage reference circuit, a phototransistor to trigger an enable pin of a flyback controller, and a control circuit. The comparator compares a voltage between a low-voltage (e.g., 12 volt) battery input and predetermined threshold voltage to trigger the phototransistor. The predetermined voltage may be a reference voltage supplied by an always-on line of electrical power on a low-voltage battery path, which may be a low voltage power supply (e.g., a PMIC (power management integrated circuit)) or other discrete device.

Embodiments of the disclosure generally increase a current capability and reduce a thermal loss on devices of redundant power supply. The circuitry inside the BMU may also include an ideal diode controller and MOSFET to increase current capability and reduce thermal loss. The system/method may improve a battery imbalance between two battery banks in a switchable high-voltage RESS. A switching circuit with a protection device on a high-voltage island side of the two battery banks in the switchable RESS may selectively connect the two battery banks in series to allow the banks to share a same load current.

An aspect of the disclosure includes system with a low-voltage battery, a rechargeable energy storage system and a battery management unit. The low-voltage battery is operational to present a low-voltage electrical power. The rechargeable energy storage system is operational to present a high-voltage electrical power. The battery management unit is electrically coupled to the low-voltage battery and the rechargeable energy storage system. The battery management unit includes: a control circuit operational to consume the low-voltage electrical power; a flyback transformer operational to convert the high-voltage electrical power into the low-voltage electrical power; a first path operational to transfer the low-voltage electrical power from the low-voltage battery to the control circuit; and a second path coupled to the first path and operational to transfer the low-voltage electrical power from the flyback transformer to the control circuit.

In another aspect of the disclosure, the battery management unit includes a flyback controller coupled to the flyback transformer and the rechargeable energy storage system, and operational to control a flow of the low-voltage electrical power on the second path.

In another aspect of the disclosure, the flyback controller, while enabled, is operational to convert direct-current power from the rechargeable energy storage system into an alternating-current power that is applied to the flyback transformer.

Another aspect of the disclosure includes a comparator operational to enable the flyback controller in response to the low-voltage battery presenting less than a threshold voltage.

In another aspect of the disclosure, the comparator is further operational to enable the flyback controller in response to a harness being disconnected between the low-voltage battery and the battery management unit.

Another aspect of the disclosure includes a low-voltage power supply coupled to the low-voltage battery, and operational to manage the low-voltage electrical power received from the first path.

Another aspect of the disclosure includes a first diode on the first path coupled between the low-voltage battery and the low-voltage power supply.

Another aspect of the disclosure includes a second diode on the second path coupled between the low-voltage power supply and the flyback transformer.

Another aspect of the disclosure includes a transistor on the second path coupled between the low-voltage power supply and the flyback transformer, and an ideal diode controller operational to control the transistor.

An aspect of the disclosure includes a method for reducing quiescent current from a high-voltage rechargeable energy storage system. The method includes: presenting a low-voltage electrical power from a low-voltage battery to a battery management unit; presenting a high-voltage electrical power from a rechargeable energy storage system to the battery management unit; consuming the low-voltage electrical power by a control circuit of the battery management unit; converting the high-voltage electrical power into the low-voltage electrical power with a flyback transformer; transferring the low-voltage electrical power from the low-voltage battery to the control circuit along a first path; and transferring the low-voltage electrical power from the flyback transformer to the control circuit along a second path coupled to the first path.

Another aspect of the disclosure includes controlling a flow of the low-voltage electrical power on the second path with a flyback controller that is coupled to the flyback transformer and the rechargeable energy storage system.

Another aspect of the disclosure includes converting direct-current power from the rechargeable energy storage system into an alternating-current power with the flyback controller while enabled, where the alternating-current power is applied to the flyback transformer.

Another aspect of the disclosure includes enabling the flyback controller with a comparator in response to the low-voltage battery presenting less than a threshold voltage.

In another aspect of the disclosure, enabling the flyback controller with the comparator in response to a harness being disconnected between the low-voltage battery and the battery management unit.

In another aspect of the disclosure, a low-voltage power supply is coupled to the low-voltage battery.

In another aspect of the disclosure, a first diode is coupled on the first path between the low-voltage battery and the low-voltage power supply.

In another aspect of the disclosure, a second diode is coupled on the second path between the low-voltage power supply and the flyback transformer.

In another aspect of the disclosure, a transistor is coupled on the second path between the low-voltage power supply and the flyback transformer; the method further includes controlling the transistor with an ideal diode controller.

An aspect of the disclosure includes a vehicle that includes a low-voltage battery, a rechargeable energy storage system and a battery management unit. The low-voltage battery is operational to present a low-voltage electrical power. The rechargeable energy storage system is operational to present a high-voltage electrical power. The battery management unit is electrically coupled to the low-voltage battery and the rechargeable energy storage system. The battery management unit includes: a control circuit operational to consume the low-voltage electrical power; a flyback transformer operational to convert the high-voltage electrical power into the low-voltage electrical power; a reversed block operational to transfer the low-voltage electrical power unidirectionally along a first path from the low-voltage battery to the control circuit; and a transistor operational that transfer the low-voltage electrical power along a second path from the flyback transformer to the control circuit.

In another aspect of the disclosure, the rechargeable energy storage system has two banks that are alternatively connected in series and in parallel.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A system comprising:
a low-voltage battery operational to present a low-voltage electrical power;
a rechargeable energy storage system operational to present a high-voltage electrical power; and
a battery management unit electrically coupled to the low-voltage battery and the rechargeable energy storage system, wherein the battery management unit includes:
a control circuit operational to consume the low-voltage electrical power;
a flyback transformer operational to convert the high-voltage electrical power into the low-voltage electrical power;
a first path operational to transfer the low-voltage electrical power from the low-voltage battery to the control circuit; and
a second path coupled to the first path and operational to transfer the low-voltage electrical power from the flyback transformer to the control circuit.

2. The system according to claim 1, wherein the battery management unit includes:
a flyback controller coupled to the flyback transformer and the rechargeable energy storage system, and operational to control a flow of the low-voltage electrical power on the second path.

3. The system according to claim 2, wherein:
the flyback controller, while enabled, is operational to convert direct-current power from the rechargeable energy storage system into an alternating-current power that is applied to the flyback transformer.

4. The system according to claim 3, further comprising:
a comparator operational to enable the flyback controller in response to the low-voltage battery presenting less than a threshold voltage.

5. The system according to claim 4, wherein:
the comparator is further operational to enable the flyback controller in response to a harness being disconnected between the low-voltage battery and the battery management unit.

6. The system according to claim 1, further comprising:
a low-voltage power supply coupled to the low-voltage battery, and operational to manage the low-voltage electrical power received from the first path.

7. The system according to claim 6, further comprising:
a first diode on the first path coupled between the low-voltage battery and the low-voltage power supply.

8. The system according to claim 7, further comprising:
a second diode on the second path coupled between the low-voltage power supply and the flyback transformer.

9. The system according to claim 7, further comprising:
a transistor on the second path coupled between the low-voltage power supply and the flyback transformer; and
an ideal diode controller operational to control the transistor.

10. A method for reducing quiescent current from a high-voltage rechargeable energy
storage system comprising:
presenting a low-voltage electrical power from a low-voltage battery to a battery management unit;
presenting a high-voltage electrical power from a rechargeable energy storage system to the battery management unit;
consuming the low-voltage electrical power by a control circuit of the battery management unit;
converting the high-voltage electrical power into the low-voltage electrical power with a flyback transformer;
transferring the low-voltage electrical power from the low-voltage battery to the control circuit along a first path; and
transferring the low-voltage electrical power from the flyback transformer to the control circuit along a second path coupled to the first path.

11. The method according to claim 10, further comprising:
controlling a flow of the low-voltage electrical power on the second path with a flyback controller that is coupled to the flyback transformer and the rechargeable energy storage system.

12. The method according to claim 11, further comprising:
converting direct-current power from the rechargeable energy storage system into an alternating-current power with the flyback controller while enabled, wherein the alternating-current power is applied to the flyback transformer.

13. The method according to claim 12, further comprising:
enabling the flyback controller with a comparator in response to the low-voltage battery presenting less than a threshold voltage.

14. The method according to claim 13, wherein:
enabling the flyback controller with the comparator in response to a harness being disconnected between the low-voltage battery and the battery management unit.

15. The method according to claim 10, further comprising:
a low-voltage power supply coupled to the low-voltage battery.

16. The method according to claim 15, wherein:
a first diode is coupled on the first path between the low-voltage battery and the low-voltage power supply.

17. The method according to claim 16, wherein:
a second diode is coupled on the second path between the low-voltage power supply and the flyback transformer.

18. The method according to claim 16, wherein a transistor is coupled on the second path between the low-voltage power supply and the flyback transformer; the method further comprising:
controlling the transistor with an ideal diode controller.

19. A vehicle comprising:
a low-voltage battery operational to present a low-voltage electrical power;
a rechargeable energy storage system operational to present a high-voltage electrical power; and
a battery management unit electrically coupled to the low-voltage battery and the rechargeable energy storage system, wherein the battery management unit includes:
a control circuit operational to consume the low-voltage electrical power;
a flyback transformer operational to convert the high-voltage electrical power into the low-voltage electrical power;
a reversed block operational to transfer the low-voltage electrical power unidirectionally along a first path from the low-voltage battery to the control circuit; and
a transistor operational that transfer the low-voltage electrical power along a second path from the flyback transformer to the control circuit.

20. The vehicle according to claim 19, wherein:
the rechargeable energy storage system has two banks that are alternatively connected in series and in parallel.
